(19) United States
(12) Patent Application Publication
(10) Pub. No.: US 2025/0217506 A1
(43) Pub. Date: Jul. 3, 2025

(54) TASK-DRIVEN PRIVACY-PRESERVING DATA-SHARING FOR DATA SHARING ECOSYSTEMS

(71) Applicant: VIRGINIA TECH INTELLECTUAL PROPERTIES, INC., Blacksburg, VA (US)

(72) Inventors: Ismini Lourentzou, Blacksburg, VA (US); Ran Jin, Blacksburg, VA (US)

(21) Appl. No.: 18/850,941

(22) PCT Filed: Jan. 31, 2023
(86) PCT No.: PCT/US2023/061660

§ 371 Date: Sep. 25, 2024

Related U.S. Application Data
(60) Provisional application No. 63/325,927, filed on Mar. 31, 2022.

(51) Int. Cl. G06F 21/62

(52) U.S. Cl. CPC G06F 21/6218

(57) ABSTRACT

Task-driven privacy-preserving data-sharing concepts are described. In one example, a method can include obtaining distilled data that respectively corresponds to multiple entities and is representative of local data of each of the multiple entities. The distilled data can be latent representations that are desensitized to defined data features in the local data. The method can also include learning a similarity between a first entity and at least one second entity of the multiple entities with respect to a defined task service based on first distilled data of the first entity and second distilled data of each of the at least one second entity. The method can also include selecting one or more data values from the second distilled data based on the similarity. The method can also include providing the data value(s) to the first entity for implementation of the defined task service based on the data value(s).

### CROSS-REFERENCE TO RELATED APPLICATION

This application claims the benefit of and priority to U.S. Provisional Patent Application No. 63/325,927, titled “TASK-DRIVEN PRIVACY-PRESERVING DATA-SHARING FOR INDUSTRIAL INTERNET,” filed Mar. 31, 2022, the entire contents of which is hereby incorporated by reference herein.

### GOVERNMENT LICENSE RIGHTS

This invention was made with government support under Grant No. 2208864 awarded by the National Science Foundation. The government has certain rights in the invention.

### BACKGROUND

A data sharing ecosystem is a partnership between multiple data owners to share their data with one another and collaborate in a manner that adds value for all participants, collectively and individually. Data sharing ecosystems typically span across different industries, such as manufacturing, energy management, healthcare, and finance.

An example of a data sharing ecosystem is an Industrial Internet, such as a Manufacturing Industrial Internet. An Industrial Internet provides a communication and computation collaboration platform for participating entities. Specifically, an Industrial Internet allows for participating entities to individually collect and share massive data with one another to facilitate certain tasks respectively performed by the participants, such as machine learning and artificial intelligence tasks in training, validation, and deployment.

### SUMMARY

The present disclosure is directed to dynamic and intelligent task-driven privacy-preserving data-sharing for a data sharing ecosystem such as, for instance, an Industrial Internet. More specifically, described herein is a data-sharing framework that can be embodied or implemented as a software architecture to combine shared privacy-preserving distilled data from different entities with local data of such entities to improve the performance of specific tasks individually performed by the different entities. In particular, the data-sharing framework can be implemented to combine shared privacy-preserving distilled data from different entities with local data of such entities based on task-driven similarities between the entities with respect to specific tasks such as, for example, supervised learning tasks.

According to an example of the data-sharing framework described herein, a plurality of entities can each reconstruct their respective local data into distilled data such that their original data is not recognizable in the distilled data but can still be used to perform certain tasks. A computing device can learn a task-driven similarity between a first entity and at least one second entity with respect to a specific task. The computing device can learn the task-driven similarity based on distilled data obtained from the first entity and each of the at least one second entity. The computing device can further select one or more data values from the distilled data of at least one entity of the at least one second entity based on the task-driven similarity.

The computing device can then provide the data value(s) to the first entity for implementation of the specific task using the data value(s) and local data of the first entity. Additionally, the computing device can also implement a reinforcement learning process to progressively learn which data value(s) are relatively most beneficial for improving the performance of the specific task. In this way, the data-sharing framework of the present disclosure can facilitate the sharing of privacy-preserving data that is the most suitable data for implementing a specific task and has been shown to improve the performance of such a task.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example data-sharing environment that can facilitate task-driven privacy-preserving data-sharing according to at least one embodiment of the present disclosure.

FIG. 2 illustrates a block diagram of an example computing environment that can facilitate task-driven privacy-preserving data-sharing according to at least one embodiment of the present disclosure.

FIG. 3 illustrates a flow diagram of an example data flow that can be implemented to facilitate task-driven privacy-preserving data-sharing according to at least one embodiment of the present disclosure.

FIG. 4 illustrates a diagram of an example similarity matrix that can be generated according to at least one embodiment of the present disclosure.

FIG. 5 illustrates a flow diagram of an example computer-implemented method that can be implemented to facilitate task-driven privacy-preserving data-sharing according to at least one embodiment of the present disclosure.

### DETAILED DESCRIPTION

As noted above, a data sharing ecosystem such as, for instance, an Industrial Internet allows for participating entities to individually collect and share massive data with one another to facilitate certain tasks respectively performed by the participants, such as machine learning and artificial intelligence tasks in training, validation, and deployment. However, a problem with effectively and efficiently implementing such a data sharing ecosystem is that the participants tend to keep data private due to increasing concerns of information privacy in connection with proprietary or sensitive information. Another problem with effectively and efficiently implementing such a data sharing ecosystem is the difficulty in determining which data will be the most useful for performing a specific task.

Some existing technologies use privacy-preserving generative adversarial networks (GAN) to generate distilled data that can be shared amongst entities participating in a data sharing ecosystem. However, these technologies do not provide for the selection of the most useful data for performing a specific task. Instead, such technologies randomly acquire data or collectively use all available datasets shared by the participants. Such random acquisition and collective use of all available datasets is not efficient, nor does it scale effectively, and it may result in negative consequences.

The present disclosure provides solutions to address the above-described problems associated with effectively and efficiently implementing such a data sharing ecosystem in general and with respect to the approaches used by existing technologies. For example, the data-sharing framework described herein can be implemented to allow for multiple data owners to share their data for implementation of specific tasks, while preserving the privacy of such data owners. The shared data can be in the form of distilled data that are intermediate representations of the original local data of each data owner. The data owners can each generate their respective distilled data such that their original local data is not recognizable, but the representations of such data in the distilled data is still useful for performing specific tasks.

The distilled data from multiple data owners can then be used in connection with an attention operator that learns a task-driven similarity between the data owners and a certain data receiver with respect to a specific task. The learned task-driven similarity can effectively allow for the selection of data from one or more of the data owners, conditioned on the corresponding data receiver and the specific task. Further, a reinforcement learning process can also be implemented to augment the learning of the task-driven similarity by assigning rewards based on the performance, for example, the prediction correctness of the specific task.

The data-sharing framework of the present disclosure provides several technical benefits and advantages. For example, the data-sharing framework described herein can reduce the time and costs (e.g., computational costs) associated with training a machine learning or artificial intelligence model that can be used to perform a certain task such as, for instance, making a prediction. In addition, the data-sharing framework of the present disclosure can improve the efficiency and operation of various computational resources used to train such a model. Further, the data-sharing framework described herein can improve the performance and accuracy of the model such as, for instance, the accuracy of predictions output by the model once it has been trained. Additionally, the data-sharing framework of the present disclosure can facilitate the forging of commercially or technically-based partnerships between different entities having task-driven similarities with one another with respect to certain tasks.

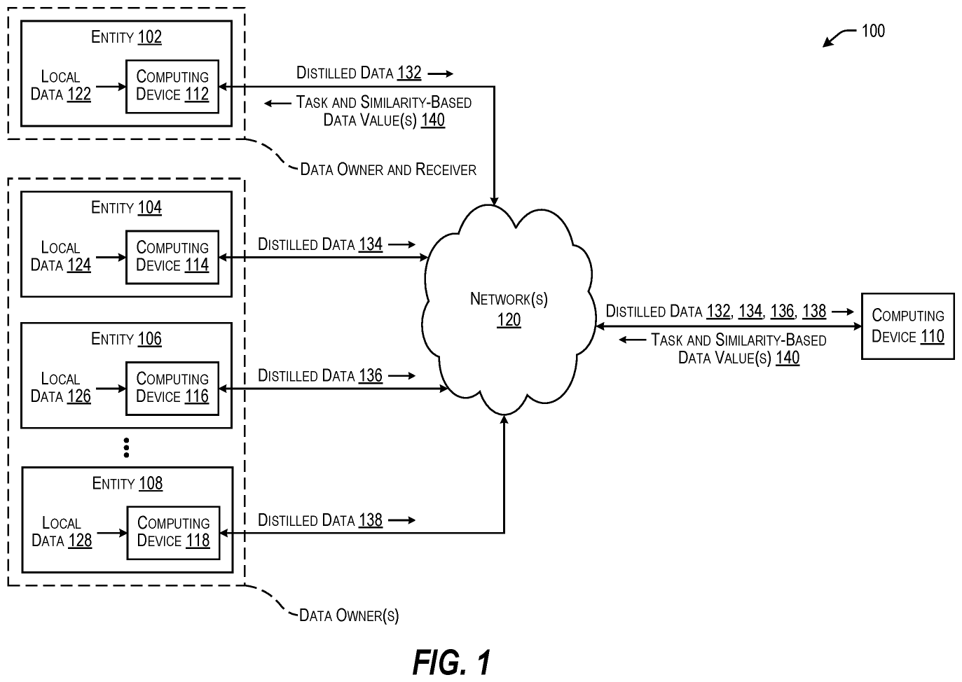

For context. FIG. 1 illustrates a block diagram of an example data-sharing environment 100 that can facilitate task-driven privacy-preserving data-sharing according to at least one embodiment of the present disclosure. In the example illustrated in FIG. 1, the data-sharing environment 100 can be an Industrial Internet data-sharing environment, an Industrial Internet of Things (IIoT) data-sharing environment, or both. However, the data-sharing framework of the present disclosure is not limited to such an environment(s).

As illustrated in FIG. 1, the data-sharing environment 100 can include multiple entities 102, 104, 106, 108 operating independently from one another Although FIG. 1 depicts four entities, the data-sharing framework of the present disclosure is not so limiting. For instance, in some cases, the data-sharing environment 100 can include as few as two entities, or any number of entities greater than two, that can implement the data-sharing framework of the present disclosure in accordance with one or more examples described herein.

In the example illustrated in FIG. 1, each of the entities 102, 104, 106, 108 can be embodied as, for instance, an enterprise, an organization, a company, another type of entity, or any combination thereof. For example, each of the entities 102, 104, 106, 108 can be an enterprise such as, for instance, a manufacturing enterprise, an energy management enterprise, another type of enterprise, or any combination thereof.

Further, each of the entities 102, 104, 106, 108 can operate one or more types of machines, instruments, or equipment, perform one or more types of processes, use one or more types of materials or recipes, produce one or more types of products, provide one or more types of services, or any combination thereof. The entities 102, 104, 106, 108 can be heterogeneous or homogeneous with respect to one another. For instance, one or more of the operations, machines, instruments, equipment, processes, materials, recipes, products, services, and the like, of any of the entities 102, 104, 106, 108 can be the same as, similar to, or different from that of any of the other entities 102, 104, 106, 108.

Additionally, any of the entities 102, 104, 106, 108 can individually implement one or more task services to perform at least one task that can be associated with their respective operation(s), machine(s), instrument(s), equipment, process(es), material(s), recipe(s), product(s), service(s), and the like. Examples of such task(s) that can be performed by such task service(s) can include, but are not limited to, at least one of training, implementing, or updating at least one of a machine learning (ML) or artificial intelligence (AI) model (ML/AI model). The ML/AI model can be respectively implemented by any of the entities 102, 104, 106, 108 in connection with their respective operation(s), machine(s), instrument(s), equipment, process(es), material(s), recipe(s), product(s), service(s), and the like.

In one example, such task(s) can include, but are not limited to, at least one of a supervised learning task associated with the ML/AI model, a semi-supervised learning task associated with the ML/AI model, or another type of learning task associated with the ML/AI model. For example, such task(s) can include at least one of training the ML/AI model on a set of training data using a supervised or semi-supervised learning process, implementing the resulting trained ML/AI model to perform a specific task, or updating the trained ML/AI model based on its performance with respect to the specific task.

In the example illustrated in FIG. 1, the entities 102, 104, 106, 108 can respectively include or be coupled to a computing device 112, 114, 116, 118 that can be used to implement one or more aspects of the data-sharing framework of the present disclosure in accordance with at least one example described herein. Each of the computing devices 112, 114, 116, 118 can in be embodied as, for instance, a client computing device, a general-purpose computer, a special-purpose computer, a laptop, a smartphone, a tablet, another type of computing device, or any combination thereof. In the examples described herein, the entities 102, 104, 106, 108 can each user their own computing device 112, 114, 116, 118 to respectively perform various operations in accordance with example embodiments of the present disclosure.

As illustrated in FIG. 1, each of the computing devices 112, 114, 116, 118 can be communicatively coupled, operatively coupled, or both to a computing device 110 by way of one or more networks 120. The computing device 110 can implement one or more aspects of the data-sharing framework in accordance with at least one example described herein. The computing device 110 can be embodied as, for instance, a server computing device, a virtual machine, a supercomputer, a quantum computer or processor, another type of computing device, or any combination thereof. In one example, the computing device 110 can be associated with a data center, physically located at such a data center, or both. However, as described below, in some cases, the computing device 110 or one or more components thereof can be included in any of the entities 102, 104, 106, 108 or their respective computing device 112, 114, 116, 118.

Although not shown in FIG. 1, in some examples of the data-sharing framework described herein, any of the entities 102, 104, 106, 108 or their respective computing device 112, 114, 116, 118 can include the computing device 110 or one or more components thereof. In one example, any of the entities 102, 104, 106, 108 can include both their respective computing device 112, 114, 116, 118 and the computing device 110 or one or more components thereof. In another example, any of the computing devices 112, 114, 116, 118 can respectively include or be embodied as the computing device 110 or one or more components thereof. In these examples, any of the entities 102, 104, 106, 108 or their respective computing device 112, 114, 116, 118 that include the computing device 110 or one or more components thereof can locally implement any or all aspects of the data-sharing framework described herein.

The network(s) 120 can include, for instance, the Internet, intranets, extranets, wide area networks (WANs), local area networks (LANs), wired networks, wireless networks (e.g. cellular, WiFi®), cable networks, satellite networks, other suitable networks, or any combinations thereof. The entities 102, 104, 106, 108 can use their respective computing device 112, 114, 116, 118 to communicate with one another and with the computing device 110 over the network(s) 120 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over network(s) 120, without limitation. Although not illustrated, network(s) 120 can also include connections to any number of other network hosts, such as website servers, file servers, networked computing resources, databases, data stores, or other network or computing architectures in some cases.

Although not illustrated in FIG. 1 for clarity purposes, the entities 102, 104, 106, 108 can each include or be coupled (e.g., communicatively, operatively) to one or more data collection devices that can measure or capture local data 122, 124, 126, 128 that can be respectively associated with the entities 102, 104, 106, 108. Examples of such data collection device(s) can include, but are not limited to, one or more sensors, actuators, instruments, manufacturing tools, programmable logic controllers (PLCs), Internet of Things (IoT) devices, IIoT devices, or any combination thereof. Additionally, the computing devices 112, 114, 116, 118 can be respectively coupled (e.g., communicatively, operatively) to the data collection device(s) of the respective entities 102, 104, 106, 108. In this way, the computing devices 112, 114, 116, 118 can respectively receive the local data 122, 124, 126, 128 of the respective entities 102, 104, 106, 108 as illustrated in FIG. 1.

The local data 122, 124, 126, 128 can correspond to, be associated with, and be owned by the entities 102, 104, 106, 108, respectively. Among other types of data, the local data 122, 124, 126, 128 can include sensor data, annotated sensor data, other type(s) of data, or any combination thereof. The sensor data can be respectively captured or measured locally by any of the entities 102, 104, 106, 108. The annotated sensor data can include sensor data that has been respectively captured or measured locally by any of the entities 102, 104, 106, 108 and further annotated, respectively, by the entities 102, 104, 106, 108 that locally captured or measured such sensor data. The sensor data, the annotated sensor data, or both can be stored locally by any of the entities 102, 104, 106, 108, respectively, that captured or measured the sensor data or created the annotated sensor data.

In various examples described herein, the local data 122, 124, 126, 128 can include or be indicative of multivariate time series (MTS) data that corresponds to, is associated with, and is owned by the entities 102, 104, 106, 108, respectively. However, the data-sharing framework of the present disclosure is not limited to MTS data or any type of data.

The local data 122, 124, 126, 128 can each include or be indicative of protected data or information, sensitive data or information, or any combination thereof. For instance, the local data 122, 124, 126, 128 can include or be indicative of proprietary data or information, empirical data or information, competitively advantageous data or information, financial data or information, employee data or information, or another type of protected or sensitive data or information that can correspond to, be associated with, and be owned by the entities 102, 104, 106, 108, respectively.

Additionally, the local data 122, 124, 126, 128 can include or be indicative of protected or sensitive data or information associated with the respective operation(s), machine(s), instrument(s), equipment, process(es), material(s), recipe(s), product(s), service(s), and the like, of each of the entities 102, 104, 106, 108. Further, the local data 122, 124, 126, 128 can be respectively used by the entities 102, 104, 106, 108 to individually implement the above-described task service(s) in connection with their respective operation(s), machine(s), instrument(s), equipment, process(es), material(s), recipe(s), product(s), service(s), and the like. For instance, the local data 122, 124, 126, 128 can be respectively used by the entities 102, 104, 106, 108 to individually train an ML or AI model using a supervised or semi-supervised learning process, implement the resulting trained model to perform a certain task, or both.

To augment the individual implementation of the above-described task service(s) by any of the entities 102, 104, 106, 108, such entities can share their respective data with one another and with the computing device 110 using the network(s) 120. However, rather than directly sharing their respective local data 122, 124, 126, 128, the entities 102, 104, 106, 108 can respectively share distilled data 132, 134, 136, 138 to safeguard any protected or sensitive data or information that may be included in or indicated by the local data 122, 124, 126, 128 as described above.

The distilled data 132, 134, 136, 138 can be respectively generated by the computing devices 112, 114, 116, 118 based on the local data 122, 124, 126, 128, respectively. For example, each of the computing devices 112, 114, 116, 118 can implement a data distillation service that can use an ML, AI, or related model to generate the distilled data 132, 134, 136, 138 based on the local data 122, 124, 126, 128, respectively. Examples of such an ML or AI model can include, but are not limited to, a deep generative model, a generative adversarial network (GAN), a variational autoencoder (VAE), a long short-term memory (LSTM) network, a related type of model, or a combination thereof.

As an example, each of the computing devices 112, 114, 116, 118 can implement a variational autoencoder long short-term memory deep generative (VAE-LSTM) model to generate the distilled data 132, 134, 136, 138 based on the local data 122, 124, 126, 128, respectively. While various examples of the data-sharing framework described herein include the use of a VAE-LSTM model to generate the distilled data 132, 134, 136, 138, the present disclosure is not limited to the use of a VAE-LSTM model.

The distilled data 132, 134, 136, 138 can include or be indicative of latent representations of the local data 122, 124, 126, 128, respectively. For example, the distilled data 132, 134, 136, 138 can include or be indicative of latent vector representations of the local data 122, 124, 126, 128, respectively. For instance, the distilled data 132, 134, 136, 138 can include or be indicative of relatively low-dimensional vector representations of the local data 122, 124, 126, 128, respectively.

The distilled data 132, 134, 136, 138, that is, the latent representations, the latent vector representations, and the relatively low-dimensional vector representations of the local data 122, 124, 126, 128 can each be invariant to protected or sensitive data features that may be included in or indicated by the local data 122, 124, 126, 128. For example, such representations can be relatively good representations for reconstructing the local data 122, 124, 126, 128, while also being relatively poor representations for reconstructing any protected or sensitive data features that may be included in or indicated by the local data 122, 124, 126, 128. For instance, the distilled data 132, 134, 136, 138 can be representations that are desensitized to certain protected or sensitive data feature(s) that may be included in or indicated by the local data 122, 124, 126, 128. As such, the distilled data 132, 134, 136, 138 can safeguard any protected or sensitive data or information that may be included in or indicated by the local data 122, 124, 126, 128, respectively. In one example, prior to generating the distilled data 132, 134, 136, 138, each of the entities 102, 104, 106, 108, respectively, can define the respective protected or sensitive data feature(s) they want safeguarded in the distilled data 132, 134, 136, 138.

To further augment the individual implementation of the above-described task service(s) by any of the entities 102, 104, 106, 108, the computing device 110 can learn one or more similarities between any of the entities 102, 104, 106, 108 with respect to a certain task service based on the distilled data 132, 134, 136, 138. For instance, for a certain task service that can be implemented by a certain entity, the computing device 110 can learn one or more similarities between that entity and at least one other entity with respect to the task service. The computing device 110 can learn such one or more similarities based on distilled data it can obtain from the entity that is to implement the task service and distilled data obtained from the at least one other entity.

In the example depicted in FIG. 1, for a certain task service that can be implemented by a certain entity such as, for example, the entity 102, the computing device 110 can learn one or more similarities between the entity 102 and at least one of the entities 104, 106, 108. The computing device 110 can learn such one or more similarities based on the distilled data 132, 134, 136, 138 that it can obtain from the entities 102, 104, 106, 108, respectively, over the network(s) 120.

As denoted in FIG. 1, the entity 102 can be both a data owner and a data receiver in this example because the entity 102 can collect and own its local data 122 and receive at least a portion of any of the distilled data 134, 136, 138 based on one or more learned similarities that may exist between the entity 102 and any of the entities 104, 106, 108. Additionally, as denoted in FIG. 1, the entities 104, 106, 108 can each be a data owner in this example because they can each collect and own their local data 124, 126, 128, respectively. However, in some examples, another entity such as, for instance, the entity 104 can be both a data owner and a data receiver. In these examples, the entities 102, 106, 108 can be data owners.

In the example illustrated in FIG. 1, the task service implemented by the entity 102 can be, for instance, a supervised or semi-supervised learning task. Additionally, the task service and the one or more similarities can be associated with the respective operation(s), machine(s), instrument(s), equipment, process(es), material(s), recipe(s), product(s), service(s), and the like, of at least two of the entities 102, 104, 106, 108.

To learn one or more similarities between the entity 102 and at least one of the entities 104, 106, 108 with respect to such a task service, the computing device 110 can implement a data selection service. The data selection service can use an attention operator to perform a pair-wise comparison between the entity 102 and each of the entities 104, 106, 108 based on the distilled data 132, 134, 136, 138. For example, at any or all time step(s) of the distilled data 132, 134, 136, 138, the computing device 110 can implement the data selection service to perform a cross-correlation similarity operation using a bilinear attention unit to compare the entity 102 with each of the entities 104, 106, 108 with respect to the task service.

More specifically, at any or all time step(s) of the distilled data 132, 134, 136, 138, the computing device 110 can implement the data selection service to calculate similarity weights that can respectively correspond to pairings of the entity 102 with each of the entities 104, 106, 108 with respect to the task service. Each of the similarity weights (also referred to herein as “attention weights”) can be indicative of a degree of similarity between the entity 102 and a certain entity of the entities 104, 106, 108 with respect to the task service. The degree of similarity can be represented as a numerical value that can range from zero (0) to one (1). In this numerical value range, a value of zero is the lowest relative degree of similarity and a value of one is the highest relative degree of similarity. Further, the time step(s) can be associated with MTS data of the distilled data 132, 134, 136, 138. That is, for instance, the time step(s) can be associated with the above-described latent representations of MTS data of the local data 122, 124, 126, 128.

In one example, a relatively high similarity weight value corresponding to a pairing of the entity 102 with a certain entity of the entities 104, 106, 108 can be indicative of a relatively high degree of similarity between the entity 102 and such a certain entity of the entities 104, 106, 108 with respect to the task service. Additionally, in this example, a relatively low similarity weight value corresponding to a pairing of the entity 102 with a certain entity of the entities 104, 106, 108 can be indicative of a relatively low degree of similarity between the entity 102 and such a certain entity of the entities 104, 106, 108 with respect to the task service.

Once the computing device 110 learns the one or more similarities between the entity 102 and at least one of the entities 104, 106, 108 with respect to the task service, the computing device 110 can implement the data selection service to select one or more data values from at least one of the distilled data 134, 136, 138 based on the one or more learned similarities. These data value(s) can constitute task and similarity-based data value(s). In the example depicted in FIG. 1, such data value(s) are denoted as “task and similarity-based data value(s) 140.”

In particular, once the computing device 110 calculates the above-described similarity weights with respect to the task service, the computing device 110 can select the task and similarity-based data value(s) 140 from at least one of the distilled data 134, 136, 138 based on the similarity weights. That is, for instance, the computing device 110 can select the task and similarity-based data value(s) 140 from at least one of the distilled data 134, 136, 138 respectively corresponding to one or more of the entities 104, 106, 108 that have a relatively high degree of similarity with the entity 102 with respect to the task service as determined based on the similarity weights. In this way, the task and similarity-based data value(s) 140 selected by the computing device 110 can include the relatively most suitable subset of the distilled data 134, 136, 138 for implementation of a specific task service by a specific entity such as the entity 102.

Once selected, the computing device 110 can provide the task and similarity-based data value(s) 140 to the entity 102 over the network(s) 120. The entity 102 can then implement the task service using at least one of the local data 122 of the entity 102 or the task and similarity-based data value(s) 140. For instance, the entity 102 can implement the task service using the local data 122 of the entity 102 and the task and similarity-based data value(s) 140 to augment such implementation of the task service by the entity 102.

As described above, in at least one example, the task service can perform one or more tasks that can include at least one of training, implementing, or updating at least one of an ML or AI model (ML/AI model) using a supervised or semi-supervised learning process. In the example depicted in FIG. 1, by providing for the use of both the local data 122 of the entity 102 and the task and similarity-based data value(s) 140 to train, implement, and/or update an ML/AI model using a supervised or semi-supervised learning process, the data-sharing framework of the present disclosure can provide several technical benefits and advantages over existing technologies.

For instance, the data-sharing framework can reduce the time and costs (e.g., computational costs) associated with performing such ML/AI model training, implementation, and/or updating operation(s). In addition, the data-sharing framework can also improve the efficiency and operation of various computational and communication resources used to perform such ML/AI model training, implementation, and/or updating operation(s). Further, the data-sharing framework can improve the performance and accuracy of the ML/AI model such as, for instance, the accuracy of predictions output by the ML/AI model once it has been trained, updated, or both.

In addition to calculating the above-described similarity weights, the computing device 110 can also implement the data selection service to calculate an aggregated similarity metric based on the similarity weights with respect to the task service. The aggregated similarity metric (also referred to herein as “attention output”) can be an aggregated data representation of the entity 102 at any or all time step(s) of the distilled data 132, 134, 136, 138. More specifically, the aggregated similarity metric can be a weighted sum of the similarity weights at any or all time step(s) of the distilled data 132, 134, 136, 138 with respect to the task service. Further, the aggregated similarity metric can be indicative of an aggregated degree of similarity between the entity 102 and the entities 104, 106, 108, collectively, with respect to the task service.

In some examples, the computing device 110 can implement a matrix generation service to generate a similarity matrix based on at least one of the above-described aggregated similarity metric or similarity weights. For example, the similarity matrix can be indicative of at least one of the aggregated similarity metric or the similarity weights. As another example, the similarity matrix can include at least one of the aggregated similarity metric or the similarity weights. For instance, the computing device 110 can implement the matrix generation service to generate a visual representation of the similarity matrix such that it is indicative of and includes at least one of the aggregated similarity metric or the similarity weights. In one example, the computing device 110 can generate such a visual representation of the similarity matrix using a user interface such as, for example, a graphical user interface (GUI) that can be rendered on a display device such as a monitor or a screen that can be included in or coupled (e.g., communicatively, operatively) to any of the computing devices 110, 112, 114, 116, 118.

In some examples, the computing device 110 can provide at least one of the task and similarity-based data value(s) 140, the similarity weights, the aggregated similarity metric, or the similarity matrix to the entity 102 over the network(s) 120. The similarity weights and the similarity matrix can each allow the entity 102 to determine which entity or entities of the entities 104, 106, 108 have at least one similarity with the entity 102 with respect to the task service. Additionally, the similarity weights and the similarity matrix can each further allow the entity 102 to determine the degree of similarity for each similarity between the entity 102 and one or more entities of the entities 104, 106, 108 with respect to the task service. Further, the aggregated similarity metric can provide the entity 102 with an aggregated degree of similarity between the entity 102 and the entities 104, 106, 108, collectively, with respect to the task service.

To augment the learning of one or more similarities between the entity 102 and any of the entities 104, 106, 108, the computing device 110 can implement a reinforcement learning service to perform a reinforcement learning process. For instance, the computing device 110 can perform the reinforcement learning process based on contribution data respectively contributed by any of the entities 102, 104, 106, 108 to the task service that can be implemented by the entity 102 and the subsequent performance of the task service based on such contribution data. For example, the computing device 110 can perform the reinforcement learning process based on contribution data respectively contributed by any of the entities 102, 104, 106, 108 to at least one of an ML or AI model (ML/AI model) that can be trained, implemented, and/or updated by the task service and the subsequent performance of the ML/AI model based on such contribution data.

In implementing such a reinforcement learning process, the computing device 110 can learn at least one correlation between contribution data that has been respectively contributed by at least one entity of the entities 102, 104, 106, 108 to the task service and the performance of the task service based on such contribution data. For example, in implementing such a reinforcement learning process, the computing device 110 can learn at least one correlation between contribution data that has been respectively contributed by at least one entity of the entities 102, 104, 106, 108 to an ML/AI model that can be trained, implemented, and/or updated by the task service and the performance of the ML/AI model based on such contribution data.

In one example, as the selection of the task and similarity-based data value(s) 140 can be a sequential process, the computing device 110 can apply a Markov Decision Process (MDP) and utilize the reinforcement learning process described above to facilitate the selection of the task and similarity-based data value(s) 140. In performing the reinforcement learning process, the computing device 110 can implement a policy network and use policy gradients for training. For example, in performing the reinforcement learning process, the computing device 110 can implement a policy network and use policy gradients to train and/or update at least one of the policy network, the task service, or a data selection service used by the computing device 110 to select the task and similarity-based data value(s) 140 based on the above-described similarity or similarities between the entity 102 and any of the entities 104, 106, 108.

In the example illustrated in FIG. 1, after implementing the reinforcement learning process and progressively learning the above-described correlation(s) between the contribution data and the performance of the task service based on such contribution data, the computing device 110 can select the task and similarity-based data value(s) 140 based on the correlation(s), the one or more similarities between the entity 102 and any of the entities 104, 106, 108, or both. For instance, after learning the correlation(s), when selecting the task and similarity-based data value(s) 140, the computing device 110 can select one or more data values from at least one of the contribution data or the distilled data 134, 136, 138 based on such a correlation(s) and the one or more similarities between the entity 102 and any of the entities 104, 106, 108. In this way, the task and similarity-based data value(s) 140 selected by the computing device 110 can include both the relatively most suitable subset of the distilled data 134, 136, 138 for implementation of this specific task service by this specific entity 102 and data value(s) that have been shown through the reinforcement learning process to improve the performance of this specific task service.

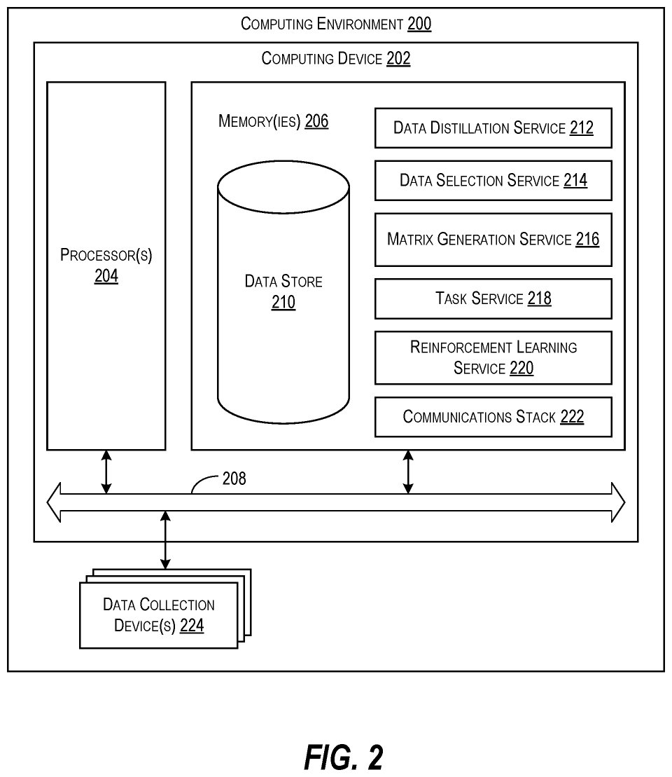

FIG. 2 illustrates a block diagram of an example the computing environment 200 that can facilitate task-driven privacy-preserving data-sharing according to at least one embodiment of the present disclosure. The computing environment 200 can include or be coupled (e.g., communicatively, operatively) to a computing device 202. With reference to FIGS. 1 and 2 collectively, in the examples described herein, the computing environment 200 can be embodied as or used to implement any of the entities 102, 104, 106, 108 and the computing device 202 can be embodied as or used to implement any of the computing devices 110, 112, 114, 116, 118. In an example where the computing device 110 can be associated with a data center, physically located at such a data center, or both, the computing environment 200 can be embodied as or used to implement the data center.

The computing device 202 can include at least one processing system, for example, having at least one processor 204 and at least one memory 206, both of which can be coupled (e.g., communicatively, electrically, operatively) to a local interface 208. The memory 206 can include a data store 210, a data distillation service 212 (also referred to herein as a “privacy-preserving data distillation service”), a data selection service 214 (also referred to herein as an “attention-based data selection service”), a matrix generation service 216, a task service 218 (also referred to herein as the “specific task service”), a reinforcement learning service 220, and a communications stack 222 in the example shown. The computing device 202 can also be coupled (e.g., communicatively, electrically, operatively) by way of the local interface 208 to one or more data collection devices 224. The computing environment 200 and the computing device 202 can also include other components that are not illustrated in FIG. 2.

The computing environment 200 can be used, in part, to embody or implement the entities 102, 104, 106, 108 and, for example, a data center that can include the computing device 110. The computing device 202 can be used, in part, to embody or implement each of the computing devices 110, 112, 114, 116, 118.

In some cases, the computing environment 200, the computing device 202, or both may or may not include all the components illustrated in FIG. 2. For example, in some cases, depending on how the computing environment 200 is embodied or implemented, the computing environment 200 may or may not include the data collection device(s) 224, and thus, the computing device 202 may or may not be coupled to the data collection device(s) 224. Also, in some cases, depending on how the computing device 202 is embodied or implemented, the memory 206 may or may not include the data distillation service 212, the data selection service 214, the matrix generation service 216, the task service 218, the reinforcement learning service 220, any combination thereof, or other components.

In examples where the computing device 110 is associated with or included in a data center, or both, the computing environment 200 can be used, in part, to embody or implement each of the entities 102, 104, 106, 108 such that they each include the data collection device(s) 224. In these examples, the computing device 202 can be used, in part, to embody or implement each of the computing devices 112, 114, 116, 118 such that they are each respectively coupled to the data collection device(s) 224. Additionally, in these examples, the computing device 202 can be used, in part, to embody or implement each of the computing devices 112, 114, 116, 118 such that the memory 206 does not include the data selection service 214, the matrix generation service 216, and the reinforcement learning service 220.

Further, in the above examples where the computing device 110 is associated with or included in a data center, or both, the computing environment 200 can be used, in part, to embody or implement the data center such that it does not include the data collection device(s) 224. In these examples, the computing device 202 can be used, in part, to embody or implement the computing device 110 such that it is not coupled to the data collection device(s) 224. Additionally, in these examples, the computing device 202 can be used, in part, to embody or implement the computing device 110 such that the memory 206 does not include the data distillation service 212.

In examples where each of the computing devices 112, 114, 116, 118 includes the computing device 110 or one or more components thereof, the computing environment 200 can be used, in part, to embody or implement each of the entities 102, 104, 106, 108 such that they each include the data collection device(s) 224. In these examples, the computing device 202 can be used, in part, to embody or implement each of the computing devices 112, 114, 116, 118 such that they are each respectively coupled to the data collection device(s) 224. Additionally, in these examples, the computing device 202 can be used, in part, to embody or implement each of the computing devices 112, 114, 116, 118 such that the memory 206 includes the data distillation service 212, the data selection service 214, the matrix generation service 216, the task service 218, and the reinforcement learning service 220, among other components.

The processor 204 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 204 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 206 can be embodied as one or more memory devices and store data and software or executable-code components executable by the processor 204. For example, the memory 206 can store executable-code components associated with the data distillation service 212, the data selection service 214, the matrix generation service 216, the task service 218, the reinforcement learning service 220, and the communications stack 222 for execution by the processor 204. The memory 206 can also store data such as the data described below that can be stored in the data store 210, among other data. For instance, the memory 206 can also store the local data 122, 124, 126, 128, the distilled data 132, 134, 136, 138, the task and similarity-based data value(s) 140, or any combination thereof.

The memory 206 can store other executable-code components for execution by the processor 204. For example, an operating system can be stored in the memory 206 for execution by the processor 204. Where any component discussed herein is implemented in the form of software, any one of a number of programming languages can be employed such as, for example, C, C++, C#, Objective C, JAVA, JAVASCRIPT″, Perl, PHP, VISUAL BASIC®, PYTHON®, RUBY, FLASH®, or other programming languages.

As discussed above, the memory 206 can store software for execution by the processor 204. In this respect, the terms “executable” or “for execution” refer to software forms that can ultimately be run or executed by the processor 204, whether in source, object, machine, or other form. Examples of executable programs include, for instance, a compiled program that can be translated into a machine code format and loaded into a random access portion of the memory 206 and executed by the processor 204, source code that can be expressed in an object code format and loaded into a random access portion of the memory 206 and executed by the processor 204, source code that can be interpreted by another executable program to generate instructions in a random access portion of the memory 206 and executed by the processor 204, or other executable programs or code.

The local interface 208 can be embodied as a data bus with an accompanying address/control bus or other addressing, control, and/or command lines. In part, the local interface 208 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 210 can include data for the computing device 202 such as, for instance, one or more unique identifiers for the computing device 202, digital certificates, encryption keys, session keys and session parameters for communications, and other data for reference and processing. The data store 210 can also store computer-readable instructions for execution by the computing device 202 via the processor 204, including instructions for the data distillation service 212, the data selection service 214, the matrix generation service 216, the task service 218, the reinforcement learning service 220, and the communications stack 222. In some cases, the data store 210 can also store the local data 122, 124, 126, 128, the distilled data 132, 134, 136, 138, the task and similarity-based data value(s) 140, or any combination thereof.

The data distillation service 212 can be embodied as one or more software applications or services executing on the computing device 202. The data distillation service 212 can be executed by the processor 204 to generate the distilled data 132, 134, 136, 138 based on the local data 122, 124, 126, 128, respectively, which can be measured or captured locally by the entities 102, 104, 106, 108, respectively. To generate the distilled data 132, 134, 136, 138 based on the local data 122, 124, 126, 128, respectively, the data distillation service 212 can implement a data distillation process (also referred to herein as a “privacy-preserving data distillation process”) using a deep generative model as described below.

As described in some examples herein, the local data 122, 124, 126, 128 can include MTS data collected locally by each of the entities 102, 104, 106, 108 using their respective sensor(s), actuator(s), instrument(s), or any combination thereof. To learn a representative, relatively low-dimensional distilled dataset for the MTS data, the data distillation service 212 can utilize a deep generative model such as, for instance, a VAE-LSTM model.

In the VAE-LSTM model, the encoder is the LSTM-based recurrence model such that for the sequential local data 122, 124, 126, 128 of each of the entities 102, 104, 106, 108 (also referred to herein as “data owners i”), the data distillation service 212 can calculate the state hᵢ^{t+1} based on the previous state hᵢ^{t} and the input Xᵢ^{t} of the current time step as shown in Equation (1) below. The data distillation service 212 can obtain the distribution of VAE latent representations from the last state of LSTM, hᵢ^{end} as shown in Equation (2) and Equation (3) below. In this LSTM-based encoder, the data distillation service 212 can initialize the initial hidden state hᵢ⁰ as a zero vector.

$${h}_{i}^{t + 1} = {LSTM}_{end} ( {h}_{i}^{t} , {X}_{i}^{t} ) \qquad ( 1 )$$

$${μ}_{{\tilde{x}}_{i}} = {W}_{μ}^{T} {h}_{i}^{end} + {b}_{μ} \qquad ( 2 )$$

$$log ( {σ}_{{\tilde{x}}_{i}} ) = {W}_{σ}^{T} {h}_{i}^{end} + {b}_{σ} \qquad ( 3 )$$

where W_{μ}, W_{σ} are learnable weight matrices, and b_{μ}, b_{σ} are bias terms. In addition, μ_{\tilde{x}}_{ᵢ} and σ_{\tilde{x}}_{ᵢ} correspond to the mean and variance of the learned latent Gaussian distribution [symbol] (μ_{\tilde{x}}_{ᵢ}, σ_{\tilde{x}}_{ᵢ}). By using the reparameterization technique, the data distillation service 212 can sample a latent representation xᵢ from the encoding distribution, that is, xᵢ˜ [symbol] (μ_{\tilde{x}}_{ᵢ},σ_{\tilde{x}}_{ᵢ}), and based on that, the data distillation service 212 can compute the initial state of the LSTM-based decoder model h′ᵢ^{t} as shown in Equation (4) and Equation (5) below. Thereafter, the data distillation service 212 can map the hidden state of each decoded time step into the multi-variate dimension of the input and reconstruct it as \tilde{X}ᵢ^{t}.

$${h}_{i}^{′0} = {W}_{z}^{T} z + {b}_{z} \qquad ( 4 )$$

where W_{z} and b_{z} are the learnable weight matrix and bias vector, respectively.

$${h}_{i}^{′t + 1} = {LSTM}_{dec} ( {h}_{i}^{′t} , {X}_{i}^{t} ) \qquad ( 5 )$$

$${\hat{X}}_{i}^{t} = {W}_{out}^{T} {h}^{′ t} + {b}_{out} \qquad ( 6 )$$

where Wₒᵤₜ is a learnable weight matrix, and bₒᵤₜ is a bias vector.

The data distillation service 212 can locally train the joint VAE-LSTM model for each data owner i based on the hybrid loss function that combines the VAE loss with the adversarial loss on protected or sensitive data features ω∈Ω that need to be safeguarded in the latent representations of the distilled data 132, 134, 136, 138. In other words, the data distillation service 212 can learn latent representations that reconstruct the input local data 122, 124, 126, 128 relatively well, while being relatively poor representations for the reconstruction of protected or sensitive data features. For instance, the data distillation service 212 can learn latent representations that are desensitized to certain protected or sensitive data feature(s) that may be included in or indicated by the local data 122, 124, 126, 128. In examples where the data distillation service 212 denotes the set of a certain quantity of protected or sensitive data features as Ω, then the data distillation service 212 can define the hybrid loss as shown below in Equation (7).

$$ℒ = {min}_{{ξ}_{M} , {θ}_{M}} {max}_{{ξ}_{D} , {θ}_{D}} \{ {‖ {X}_{i} - {h}_{{θ}_{M}} ( {g}_{{ξ}_{M}} ( {\tilde{x}}_{i} \vert {X}_{i} ) ) ‖}^{2} + {D}_{KL} ( {μ}_{{\tilde{x}}_{i}} , {σ}_{{\tilde{x}}_{i}} ‖ 𝒩 ( 0 , 1 ) ) + - λ {‖ {\{ {X}_{i} \}}_{w ∈ Ω} - {[ {h}_{{θ}_{D}} ( {g}_{{ξ}_{D}} ( {\tilde{x}}_{i} \vert {X}_{i} ) ) ]}_{w ∈ Ω} ‖}^{2} \} \qquad ( 7 )$$

where ξ_{M} and θ_{M} refer to the main model encoder and decoder parameters; and θ_{D} refers to the discriminator decoder parameters. In this objective function, the first two terms of the loss refer to the VAE loss. The VAE loss includes the input reconstruction squared error on non-protected or non-sensitive data features and the Kullback-Leibler (KL) divergence minimization between the learned distribution (μ_{\tilde{x}}_{ᵢ},σ_{\tilde{x}}_{ᵢ}) and the latent distribution, which the data distillation service 212 can assume to be a standard Gaussian distribution [symbol] (0, 1). In this term, μ_{\tilde{x}}_{ᵢ} and σ_{\tilde{x}}_{ᵢ} corresponds to the mean and variance for the learned distribution. The negative sign of the third term, which is referred to as the adversarial loss, can be implemented by the data distillation service 212 using the gradient reversal layer during backpropagation. In other words, the data distillation service 212 can reverse the sign of the gradients for the reconstruction of protected or sensitive data features ω∈Ω to provide for the VAE latent representations to be maximally poor for the reconstruction of the protected or sensitive data features.

The data selection service 214 can be embodied as one or more software applications or services executing on the computing device 202. The data selection service 214 can be executed by the processor 204 to learn one or more similarities between a certain entity such as, for instance, the entity 102 and at least one other entity such as, for instance, any of the entities 104, 106, 108 with respect to a certain task service that can be implemented by the entity 102. The data selection service 214 can learn such one or more similarities based on the distilled data 132, 134, 136, 138 that can be respectively generated by the entities 102, 104, 106, 108 using the data distillation service 212 as described above. To learn such one or more similarities, the data selection service 214 can implement an attention-based data selection process (also referred to herein as a “data selection process”) using an attention operator as described below.

After the data distillation service 212 respectively generates the distilled data 132, 134, 136, 138 for the entities 102, 104, 106, 108, that is, for each data owner i, that is, \tilde{x}ᵢ ∈ [symbol] ^{d}^{ᵢ} as described above, the data selection service 214 can project them all to the multi-view projection layer ϕ(·) with the same dimension d for all data owners i, that is, for all of the entities 102, 104, 106, 108. Therefore, the data selection service 214 can compute ϕ(\tilde{x}ᵢ)∈ [symbol] ^{d}, ∀i∈ [symbol] . Then, at each time step t, the data selection service 214 can determine the similarity among the entities 102, 104, 106, 108 for data-sharing by formulating the problem as a multi-armed attention mechanism.

At each time step t, the data selection service 214 can implement an attention operator to quantify the cross-correlation similarity between each of the entities 104, 106, 108 and the entity 102, that is, between data receiver k and each data owner i∈ [symbol] ₋ₖ based on a bilinear attention unit as shown in Equation (8) below. In other words, the data selection service 214 can implement an attention operator to perform a cross-correlation similarity operation using a bilinear attention unit that compares the entity 102 with each of the entities 104, 106, 108, that is, it compares data receiver k with each data owner i. The data selection service 214 can progressively learn the weight matrix W_{k,i}^{t}∈ [symbol] ^{d×d} over time using backpropagation. Then, the data selection service 214 can compute attention weights (also referred to herein as “similarity weights”) by normalizing and transforming to the probability distribution as shown in Equation (9) below.

$${sim}^{t} ( {\tilde{x}}_{k} , {\tilde{x}}_{i} ) = {ϕ}^{T} ( {x}_{k} ) \cdot {W}_{k , i}^{t} \cdot ϕ ( {\tilde{x}}_{i} ) \qquad ( 8 )$$

$${a}_{k , i}^{t} = \frac{{sim}^{t} ( {\tilde{x}}_{k} , {\tilde{x}}_{i} )}{{sim}^{t} ( {\tilde{x}}_{k} , \tilde{x} )} \qquad ( 9 )$$

where a_{k,i}^{t} refer to the attention weights between the entity 102 and each of the entities 104, 106, 108, that is, between data receiver k and each data owner i at time step t. After learning these attention weights for a specific task service that can be implemented by a specific entity such as the entity 102, the data selection service 214 can quantify one or more similarities between the entity 102 and each of the entities 102, 104, 106, 108, that is, between each data receiver k and each of the other data owners i∈ [symbol] ₋ₖ. These one or more similarities can constitute one or more task-driven similarities. Finally, the data selection service 214 can use Equation (10) below to compute the attention output, cₖ^{t}, as the aggregated data representation of data receiver k at time step: based on the weighted sum of attention weights and the distilled data 132, 134, 136, 138 from the entities 102, 104, 106, 108, respectively. The attention output, cₖ^{t}, is also referred to herein as an “aggregated similarity metric.”

$${c}_{k}^{t} = {a}_{k , i}^{t} {\tilde{x}}_{i} \qquad ( 10 )$$

Here the attention weights a_{k,i}^{t} indicate the preference of the data receiver k, that is, the entity 102, and determine the selection among data owners i. The attention weights can capture any inherent similarities between the entities 102, 104, 106, 108 and can be used by any of the entities 102, 104, 106, 108 to query data points based on performance improvements on the specific task service.

The attention output can be used as the input to the reinforcement learning service 220, which can implement a reinforcement learning policy-gradient for training at least one of the data selection service 214 or the specific task service that can be implemented by the entity 102. The ultimate objective of data sharing between the entity 102 and the entities 104, 106, 108, that is, between data receiver k and data owners i, is to improve the modeling performance of the specific task service, which can be a supervised learning task. As such, the attention output can be used by the reinforcement learning service 220, for example, to update at least one of the data selection service 214 or the supervised learning task at time t.

The matrix generation service 216 can be embodied as one or more software applications or services executing on the computing device 202. The matrix generation service 216 can be executed by the processor 204 to generate a similarity matrix based on at least one of the above-described aggregated similarity metric (attention output) or similarity weights (attention weights) with respect to the specific task service, which can be a supervised learning task. The similarity weights (attention weights) and aggregated similarity metric (attention output) can be calculated by the data selection service 214 as described above and provided to the matrix generation service 216.

As an example, upon receipt of at least one of the similarity weights or the aggregated similarity metric, the matrix generation service 216 can generate a similarity matrix that can be indicative of, include, or both, at least one of the aggregated similarity metric or the similarity weights. In this example, the matrix generation service 216 can generate the similarity matrix such that when it is rendered via a GUI on a display device, it can provide a visual representation of at least one of the aggregated similarity metric or the similarity weights with respect to the specific task service. For instance, such a similarity matrix can provide a visual representation of at least one of the degrees of similarity between the entity 102 and each of the entities 104, 106, 108 or an aggregated degree of similarity between the entity 102 and all of the entities 104, 106, 108, collectively, with respect to the specific task service.

The task service 218 can be embodied as one or more software applications or services executing on the computing device 202. The task service 218 can be executed by the processor 204 to perform at least one task that can be associated with the respective operation(s), machine(s), instrument(s), equipment, process(es), material(s), recipe(s), product(s), service(s), and the like, of the entities 102, 104, 106, 108. For example, the task service 218 can perform at least one of training, implementing, or updating at least one of an ML or AI model (ML/AI model). The ML/AI model can be respectively implemented by any of the entities 102, 104, 106, 108 in connection with their respective operation(s), machine(s), instrument(s), equipment, process(es), material(s), recipe(s), product(s), service(s), and the like.

In one example, the task service 218 can perform at least one of a supervised learning task associated with the ML/AI model, a semi-supervised learning task associated with the ML/AI model, or another type of learning task associated with the M/AI model. For instance, the task service 218 can perform at least one of training the ML/AI model on a set of training data using a supervised or semi-supervised learning process, implementing the resulting trained ML/AI model to perform a specific task, or updating the trained ML/AI model based on its performance with respect to the specific task.

The reinforcement learning service 220 can be embodied as one or more software applications or services executing on the computing device 202. The reinforcement learning service 220 can be executed by the processor 204 to augment the learning by the data selection service 214 of one or more similarities between the entity 102 and any of the entities 104, 106, 108. To augment such learning of the one or more similarities, the reinforcement learning service 220 can perform the reinforcement learning process described below that can include implementing a policy network and using policy gradients for training.

As the selection of the task and similarity-based data value(s) 140 can be a sequential process, the reinforcement learning service 220 can formulate a supervised learning task that can be trained, implemented, and/or updated by the task service 218 as a sequential decision-making problem such as, for instance, a Markov Decision Process (MDP). The reinforcement learning service 220 can then utilize the reinforcement learning process described below to optimize the similarity weights, that is, to augment the learning of the one or more similarities between the entity 102 and any of the entities 104, 106, 108. For the entity 102, that is data receiver k, the reinforcement learning service 220 can formulate the sequential decision-making problem as follows.

State [symbol] : The reinforcement learning service 220 can determine the state of the environment at time t using the multi-view projection vectors φ^{t}(\tilde{x}ᵢ)(i∈ [symbol] ₋ₖ).

Action [symbol] : The reinforcement learning service 220 can define the action as the prediction of a label by the task service 218, that is, the prediction of a label by an ML/AI model that can be trained, implemented, and/or updated by the task service 218. For instance, for a binary classification problem, the reinforcement learning service 220 can define the action as [symbol] ={0, 1}.

Transition Probability [symbol] : After determining the attention weights, the transition probability P(sₜ₊₁|sₜ,aₜ) is deterministic. For instance, after the data selection service 214 calculates the attention weights as described above, the reinforcement learning service 220 can define the transition probability such that it is deterministic.

Reward [symbol] : To encourage the selection of data by the data selection service 214 that improve the performance of the task service 218, that is, the performance of the ML/AI model that can be trained, implemented, and/or updated by the task service 218, the reinforcement learning service 220 can define the reward as the relative change of the correctness of predicting one sample over the updating iteration of the attention weights. To address the potential imbalance in the binary classification task, the reinforcement learning service 220 can use a numerical value of one (1) to represent the minority class and a numerical value of zero (0) to represent the majority class, and can define the correctness as follows:

$$Cr ( {a}_{t} , {l}_{t} ) = \{ \begin{matrix}1 , {a}_{t} = {l}_{t} and {l}_{t} = 0 , \\ - 1 , {a}_{t} \neq {l}_{t} and {l}_{t} = 0 , \\ λ , {a}_{t} = {l}_{t} and {l}_{t} = 1 , \\ - λ , {a}_{tt} and {l}_{t} = 1 ,\end{matrix} \qquad ( 11 )$$

where lₜ is the label for sample xₜ, λ∈[0, 1]. Accordingly, the reinforcement learning service 220 can define the reward received at time t+I as:

$$r ( {a}_{t + 1} , {l}_{t + 1} ) = Cr ( {a}_{t + 1} , {l}_{t + 1} ) - Cr ( {a}_{t} , {l}_{t} ) . \qquad ( 12 )$$

Policy π_{θ}(ϕ^{t}(\tilde{x})|cₖ^{t}). The reinforcement learning service 220 can use a policy function π_{θ}(a^{t}|sₜ) to map a state sₜ to an action aₜ. The reinforcement learning service 220 can define the policy function as the attention weights a_{k,i}^{t} as well as the parameters in the task service 218 denoted by β, that is θ=[a_{k,i}^{t};β], i∈ [symbol] ₋ₖ, that is, the parameters of the ML/AI model that can be trained, implement, and/or updated by the task service 218. The objective of this reinforcement learning problem is to gain the highest cumulative reward over time via optimizing the policy. As such, the reinforcement learning service 220 can define the loss function as:

$$L ( θ ) = - {\sum }_{t = 0}^{∞} {γ}^{t} {r}_{t + 1} , \qquad ( 13 )$$

where γ∈[0, 1] is a discount factor that allows the reinforcement learning service 220 to balance the immediate and future reward. To optimize the data sharing decisions online (e.g., after deployment, during operation), the reinforcement learning service 220 can use a policy gradient algorithm, and can rewrite the loss function as:

$$L ( θ ) = - 𝔼 [ {\sum }_{t = 1}^{T - 1} {γ}^{t} {r}_{t + 1} \vert {π}_{θ} ] = {\sum }_{t = i}^{t - 1} P ( {s}_{t} , {a}_{t} \vert τ ) {r}_{t + 1} , \qquad ( 14 )$$

where [symbol] is the trajectory ( [symbol] ={s₀, a₀, r₁, . . . , s_{T}, a_{T}, r_{T+1}}), i is an arbitrary starting point in the trajectory. Therefore, the reinforcement learning service 220 can derive the updating of policy parameter(s) as:

$${θ}_{t + 1} := {θ}_{t} - {∇}_{{θ}_{t}} L ( {θ}_{t} ) \qquad ( 15 )$$

$${∇}_{{θ}_{t}} L ( {θ}_{t} ) = {\sum }_{t = i}^{T - 1} {r}_{t + 1} ( {\sum }_{{t}^{′} = 0}^{t} {∇}_{{θ}_{t}} log {π}_{{θ}_{t}} ( {a}_{t}^{′} \vert {s}_{t}^{′} ) ) . \qquad ( 16 )$$

The communications stack 222 can include software and hardware layers to implement data communications such as, for instance, Bluetooth®, BLE, WiFi®, cellular data communications interfaces, or a combination thereof. Thus, the communications stack 222 can be relied upon by each of the computing devices 110, 112, 114, 116, 118 to establish cellular, Bluetooth®, WiFi®, and other communications channels with the network(s) 120 and with one another. The communications stack 222 can include the software and hardware to implement Bluetooth®, BLE, and related networking interfaces, which provide for a variety of different network configurations and flexible networking protocols for short-range, low-power wireless communications. The communications stack 222 can also include the software and hardware to implement WiFi® communication, and cellular communication, which also offers a variety of different network configurations and flexible networking protocols for mid-range, long-range, wireless, and cellular communications. The communications stack 222 can also incorporate the software and hardware to implement other communications interfaces, such as X10®, ZigBee®, Z-Wave®, and others. The communications stack 222 can be configured to communicate various data amongst the computing devices 110, 112, 114, 116, 118 such as, for instance, the distilled data 132, 134, 136, 138, the task and similarity-based data value(s) 140, as well as the above-described similarity weights, aggregated similarity metric, and similarity matrix according to examples described herein.

The data collection device(s) 224 can be embodied as one or more of the above-described sensor(s), actuator(s), or instrument(s) that can be included in or coupled (e.g., communicatively, operatively) to and respectively used by any of the entities 102, 104, 106, 108 to capture or measure their respective local data 122, 124, 126, 128. The data collection device(s) 224 can include at least one of sensor(s), actuator(s), or instrument(s) that allow for the capture or measurement of various types of data associated with the respective operation(s), machine(s), instrument(s), equipment, process(es), material(s), recipe(s), product(s), service(s), and the like, of the entities 102, 104, 106, 108.

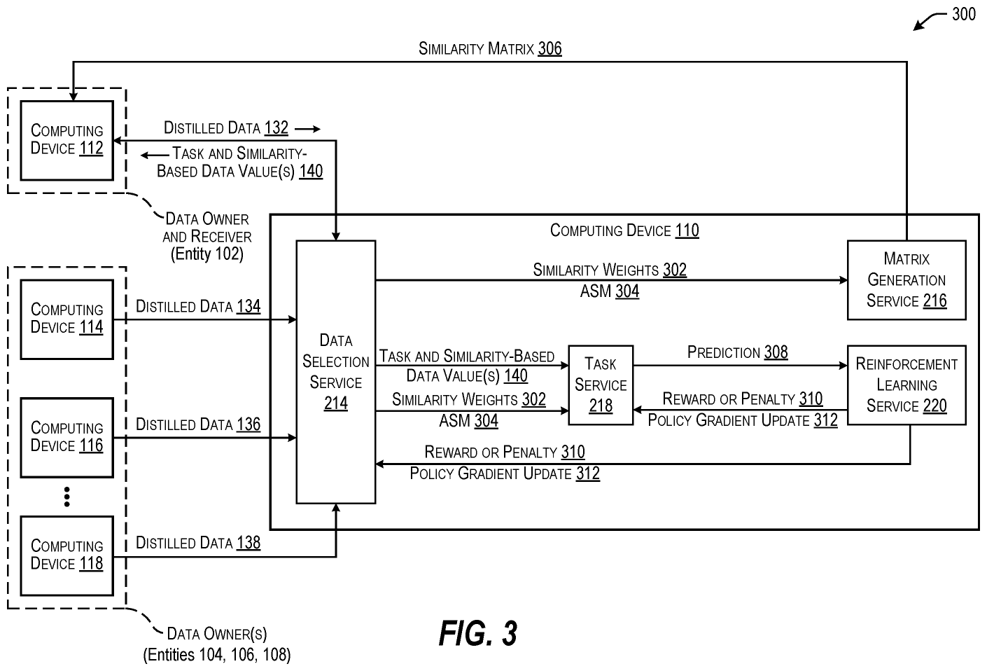

FIG. 3 illustrates a flow diagram of an example data flow 300 that can be implemented to facilitate task-driven privacy-preserving data-sharing according to at least one embodiment of the present disclosure. The data flow 300 illustrates the flow of various data after the data selection service 214 learns the above-described similarity weights, calculates the above-described aggregated similarity metric, and selects the task and similarity-based data value(s) 140 based on the distilled data 132, 134, 136, 138 of the entities 102, 104, 106, 108, respectively. The similarity weights are denoted in FIG. 3 as “similarity weights 302” and the aggregated similarity metric is denoted in FIG. 3 as “aggregated similarity metric (ASM) 304.”

In the example depicted in FIG. 3, the data selection service 214 can provide at least one of the similarity weights 302 or the ASM 304 to the matrix generation service 216. Upon obtaining at least one of the similarity weights 302 or the ASM 304, the matrix generation service 216 can generate a similarity matrix 306 and further provide the similarity matrix 306 to the computing device 112 of the entity 102. The similarity matrix 306 can be embodied as, for instance, the similarity matrix described above with reference to FIGS. 1 and 2, which can be indicative of and/or include at least one of the similarity weights 302 or the ASM 304. In this way, the data selection service 214 can provide at least one of the similarity weights 302 or the ASM 304 to the computing device 112 of the entity 102 in the form of the similarity matrix 306 by way of the matrix generation service 216.

Although not illustrated in FIG. 3 for purposes of clarity, in addition to the computing device 110 including the task service 218, the computing device 112 of the entity 102 can also include the task service 218 as described above with reference to FIG. 2. For example, the computing device 112 of the entity 102 can include a client version of the task service 218, while the computing device 110 can include a server version of the task service 218. The attributes and functionality of both the client version and the server version of the task service 218 can be the same or similar for purposes of illustrating various aspects of the data-sharing framework described herein.

In the example depicted in FIG. 3, the computing device 112 of the entity 102 can implement the client version of the task service 218 to perform one or more tasks in connection with the operation(s), machine(s), instrument(s), equipment, process(es), material(s), recipe(s), product(s), service(s), and the like, of the entity 102 based on the task and similarity-based data value(s) 140. Additionally, the computing device 110 can implement the server version of the task service 218 based on the task and similarity-based data value(s) 140 and further implement the reinforcement learning service 220 to perform the reinforcement learning process described above with reference to FIG. 2.

With regard to the server version of the task service 218 included in the computing device 110 as illustrated in FIG. 3, the data collection device(s) 224 can provide at least one of the task and similarity-based data value(s) 140, the similarity weights 302, or the ASM 304 to the task service 218. Upon obtaining at least one of the task and similarity-based data value(s) 140, the similarity weights 302, or the ASM 304, the task service 218 can use the data it receives to generate a prediction 308. For instance, as described above with reference to FIGS. 1 and 2, the task service 218 can perform at least one of training, implementing, and/or updating an ML/AI model using a supervised learning process. In the example depicted in FIG. 3, the task service 218 can use at least one of the task and similarity-based data value(s) 140, the similarity weights 302, or the ASM 304 to train, implement, and/or update such an ML/AI model. In this example, the task service 218 can use the task and similarity-based data value(s) 140 as input to such an ML/AI model, which can then generate the prediction 308.

Upon obtaining the prediction 308, the reinforcement learning service 220 can generate at least one of a reward or penalty 310 or a policy gradient update 312 by implementing the reinforcement learning process described above with reference to FIG. 2. The reinforcement learning service 220 can further provide at least one of the reward or penalty 310 or the policy gradient update 312 to at least one of the data selection service 214 or the task service 218.

Upon obtaining at least one of the reward or penalty 310 or the policy gradient update 312, the data selection service 214 can then use the data it receives to update at least one of the similarity weights 302 or the ASM 304. In this way, the data selection service 214 can augment at least one of the learning of the similarity weights 302 or the selection of the task and similarity-based data value(s) 140 by the data selection service 214.

Similarly, upon obtaining at least one of the reward or penalty 310 or the policy gradient update 312, the task service 218 can then use the data it receives to update at least one of the similarity weights 302 or the ASM 304 that it receives from the data selection service 214. In this way, the task service 218 can improve the accuracy of the prediction 308 generated by the task service 218.

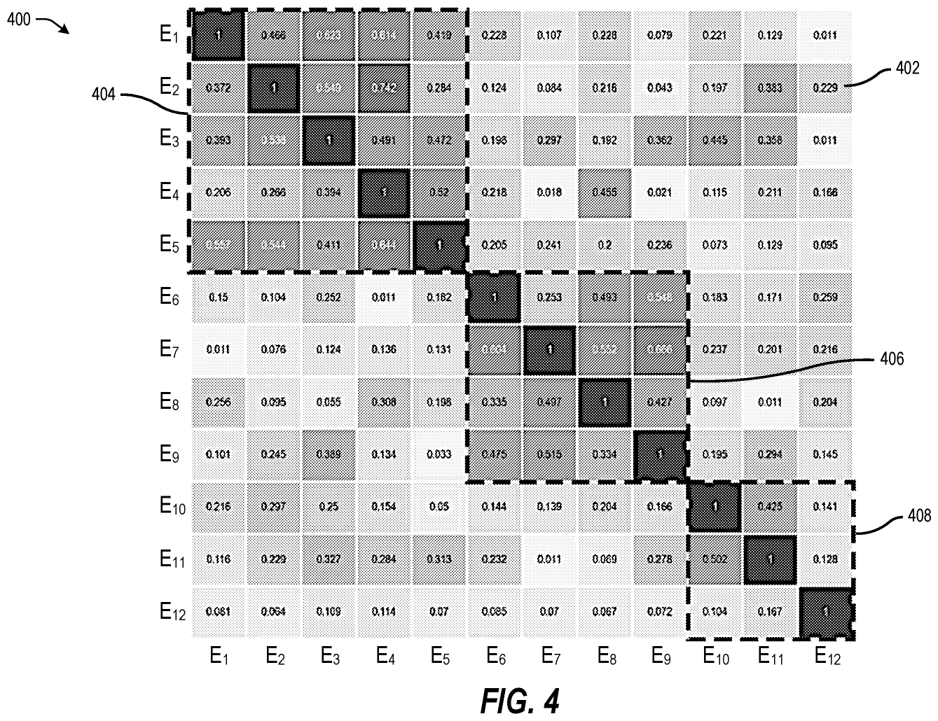

FIG. 4 illustrates a diagram of an example similarity matrix 400 that can be generated according to at least one embodiment of the present disclosure. For example, the similarity matrix 400 depicted in FIG. 4 can be an example of the similarity matrix 306 that can be generated by the matrix generation service 216 with respect to a specific task service that can be implemented by a specific entity as described above with reference to FIGS. 1, 2, and 3. For instance, the similarity matrix 400 can be an example of a similarity matrix that can be generated by the matrix generation service 216 with respect to the task service 218 that can be implemented by the entity 102.

In the example depicted in FIG. 4, the similarity matrix 400 can include similarity weights 402 that respectively correspond to different pairings of twelve (12) different entities E₁, E₂, E₃, E₄, E₅, E₆, E₇, E₈, E₉, E₁₀, E₁₁, E₁₂ with respect to a specific task service that can be individually implemented by any of such entities. Although the similarity matrix 400 illustrated in FIG. 4 includes twelve entities and one hundred and forty-four (144) similarity weights 402, other similarity matrices generated by the matrix generation service 216 can include a different number of entities, and thus, a different number of similarity weights. For instance, other example similarity matrices generated by the matrix generation service 216 can include at least two (2) entities and at least four (4) similarity weights.

In the example illustrated in FIG. 4, each of the similarity weights 402 of the similarity matrix 400 is represented by a cell that includes a numerical value corresponding to the value of the similarity weight 402. In this example, the numerical value is indicative of a degree of similarity between a certain entity and another entity with respect to a specific task service. Further, in this example, each cell is color-coded such that darker colored cells correspond to relatively higher similarity weight values and relatively higher degrees of similarity, while lighter colored cells correspond to relatively lower similarity weight values and relatively lower degrees of similarity. Only a single similarity weight 402 is annotated in FIG. 4 for clarity.

In the example depicted in FIG. 4, as each cell of the similarity matrix 400 includes the numerical value corresponding to a certain similarity weight 402 and each cell is color-coded based on such a numerical value, the similarity matrix 400 provides for convenient and advantageous analysis of the similarity weights 402 between a certain entity and each of the remaining entities with respect to a specific task service. For example, as illustrated by the dashed-line annotations of entity subsets 404, 406, 408 in FIG. 4, the similarity matrix 400 provides for convenient and advantageous analysis of the similarity weights 402 between a certain entity in a subset of entities and each of the remaining entities in the subset with respect to a specific task service.

For a specific task service, existing technologies only group entities into the entity subsets 404, 406, 408 without providing any visual or numerical indication of the different degrees of similarity between the entities in each of the entity subsets 404, 406, 408. In contrast, as demonstrated by the similarity weights 402 in each of the entity subsets 404, 406, 408 illustrated in FIG. 4, the similarity matrix 400 provides a more granular representation of the different degrees of similarity between the entities of each of the entity subsets 404, 406, 408 with respect to a specific task service.

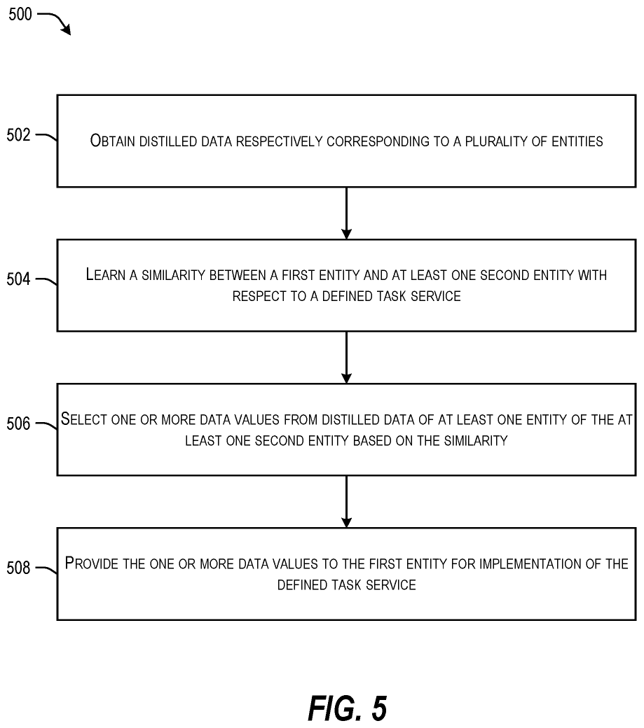

FIG. 5 illustrates a flow diagram of an example computer-implemented method that can be implemented to facilitate task-driven privacy-preserving data-sharing according to at least one embodiment of the present disclosure. In one example, computer-implemented method 500 (hereinafter, “method 500”) can be implemented by the computing device 110. In another example, method 500 can be implemented by any of the entities 102, 104, 106, 108 using, for instance, their respective computing device 112, 114, 116, 118 (e.g., the computing device 202). In this example, the computing devices 112, 114, 116, 118 can each include the computing device 110 or one or more components thereof such as, for instance, the data selection service 214, the matrix generation service 216, and the reinforcement learning service 220. The method 500 can be implemented in the context of data-sharing environment 100, the computing environment 200 or another environment, and the data flow 300.

At 502, method 500 can include obtaining distilled data respectively corresponding to a plurality of entities. For example, the computing device 110 can obtain the distilled data 132, 134, 136, 138 from the entities 102, 104, 106, 108, respectively. In this example, the distilled data 132, 134, 136, 138 can be representative of the local data 122, 124, 126, 128 described above that can be respectively collected by, associated with, and/or owned by the entities 102, 104, 106, 108.

At 504, method 500 can include learning a similarity between a first entity and at least one second entity with respect to a defined task service. For example, for a specific task service, the computing device 110 can implement the data selection service 214 to learn one or more similarities between the entity 102 and each of the entities 104, 106, 108. For instance, in this example, the computing device 110 can implement the data selection service 214 to learn at least one of the similarity weights 302 or the ASM 304 based on the distilled data 132, 134, 136, 138.

At 506, method 500 can include selecting one or more data values from distilled data of at least one entity of the at least one second entity based on the similarity. For example, based on learning the similarity between the entity 102 and each of the entities 104, 106, 108 with respect to a specific task service, the computing device 110 can further implement the data selection service 214 to select the task and similarity-based data value(s) 140 from the distilled data 132, 134, 136, 138 based on the similarity.

At 508, method 500 can include providing the one or more data values to the first entity for implementation of the defined task service. For example, the computing device 110 can provide the task and similarity-based data value(s) 140 to the entity 102 over the network(s) 120 for implementation of the task service 218 by the computing device 112 of the entity 102. In this example, the computing device 112 of the entity 102 can implement the task service 218 using at least one of its own local data 122 or the task and similarity-based data value(s) 140.

Referring now to FIG. 2, an executable program can be stored in any portion or component of the memory 206 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 206 can include both volatile and nonvolatile memory and data storage components. Volatile components are those that do not retain data values upon loss of power. Nonvolatile components are those that retain data upon a loss of power. Thus, the memory 206 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the data distillation service 212, the data selection service 214, the matrix generation service 216, the task service 218, the reinforcement learning service 220, and the communications stack 222 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 5, the flowchart or process diagram shown in FIG. 5 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 204. The machine code can be converted from the source code. Further, each block can represent, or be connected with, a circuit or a number of interconnected circuits to implement a certain logical function or process step.

Although the flowchart or process diagram shown in FIG. 5 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the data distillation service 212, the data selection service 214, the matrix generation service 216, the task service 218, the reinforcement learning service 220, and the communications stack 222 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 5. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives. USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X. Y. or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method to provide task-driven privacy-preserving data-sharing, comprising:
obtaining, by a computing device, distilled data respectively corresponding to a plurality of entities, the distilled data being representative of local data of each of the plurality of entities;
learning, by the computing device, a similarity between a first entity of the plurality of entities and at least one second entity of the plurality of entities with respect to a defined task service based on first distilled data of the first entity and second distilled data of each of the at least one second entity, the distilled data comprising the first distilled data and the second distilled data;
selecting, by the computing device, one or more data values from the second distilled data based on the similarity; and
providing, by the computing device, the one or more data values to the first entity for implementation of the defined task service based on the one or more data values.

2. The method to provide task-driven privacy-preserving data-sharing of claim 1, wherein the distilled data, the first distilled data, and the second distilled data respectively comprise latent representations generated using a variational autoencoder long short-term memory deep generative model, the latent representations being invariant to defined features of each of the distilled data, the first distilled data, and the second distilled data.

3. The method to provide task-driven privacy-preserving data-sharing of claim 1, wherein learning the similarity comprises:
performing, by the computing device, a cross-correlation similarity operation using a bilinear attention unit to compare the first entity with each of the at least one second entity with respect to the defined task service based on the first distilled data and the second distilled data.

4. The method to provide task-driven privacy-preserving data-sharing of claim 1, wherein learning the similarity comprises:
calculating, by the computing device, similarity weights respectively corresponding to pairings of the first entity with each of the at least one second entity with respect to the defined task service based on the first distilled data and the second distilled data,
wherein each of the similarity weights are indicative of a degree of similarity between the first entity and a defined entity of the at least one second entity with respect to the defined task service.

5. The method to provide task-driven privacy-preserving data-sharing of claim 4, wherein selecting the one or more data values comprises:
selecting, by the computing device, the one or more data values from the second distilled data of the at least one entity of the at least one second entity based on the similarity weights.

6. The method to provide task-driven privacy-preserving data-sharing of claim 1, wherein the first distilled data and the second distilled data respectively comprise latent representations of multi-variate time series data respectively obtained locally by the first entity and each of the at least one second entity.

7. The method to provide task-driven privacy-preserving data-sharing of claim 6, wherein learning the similarity comprises:
learning, by the computing device, the similarity between the first entity and each of the at least one second entity, respectively, at one or more time steps with respect to the defined task service, the one or more time steps being associated with the multi-variate time series data.

8. The method to provide task-driven privacy-preserving data-sharing of claim 1, further comprising:
implementing, by the computing device, a reinforcement learning process based on contribution data respectively contributed by the at least one second entity to the defined task service and performance of the defined task service based on such contribution data.

9. The method to provide task-driven privacy-preserving data-sharing of claim 1, further comprising:
learning, by the computing device, at least one correlation between contribution data respectively contributed by the at least one entity of the at least one second entity to the defined task service and performance of the defined task service based on such contribution data.

10. The method to provide task-driven privacy-preserving data-sharing of claim 9, wherein selecting the one or more data values comprises:
selecting, by the computing device, at least one data value from at least one of the contribution data or the second distilled data of the at least one entity of the at least one second entity based on the similarity and the at least one correlation.

11. A computing device, comprising:
a memory device to store computer-readable instructions thereon; and
at least one processing device configured through execution of the computer-readable instructions to:
obtain distilled data respectively corresponding to a plurality of entities, the distilled data being representative of local data of each of the plurality of entities;
learn a similarity between a first entity of the plurality of entities and at least one second entity of the plurality of entities with respect to a defined task service based on first distilled data of the first entity and second distilled data of each of the at least one second entity, the distilled data comprising the first distilled data and the second distilled data;
select one or more data values from the second distilled data based on the similarity; and
provide the one or more data values to the first entity for implementation of the defined task service based on the one or more data values.

12. The computing device of claim 11, wherein the distilled data, the first distilled data, and the second distilled data respectively comprise latent representations generated using a variational autoencoder long short-term memory deep generative model, the latent representations being invariant to defined features of each of the distilled data, the first distilled data, and the second distilled data.

13. The computing device of claim 11, wherein, to learn the similarity, the at least one processing device is further configured to:
perform a cross-correlation similarity operation using a bilinear attention unit to compare the first entity with each of the at least one second entity with respect to the defined task service based on the first distilled data and the second distilled data.

14. The computing device of claim 11, wherein the first distilled data and the second distilled data respectively comprise latent representations of multi-variate time series data respectively obtained locally by the first entity and each of the at least one second entity.

15. The computing device of claim 14, wherein, to learn the similarity, the at least one processing device is further configured to:
learn the similarity between the first entity and each of the at least one second entity, respectively, at one or more time steps with respect to the defined task service, the one or more time steps being associated with the multi-variate time series data.

16. The computing device of claim 11, wherein the at least one processing device is further configured to:
learn at least one correlation between contribution data respectively contributed by the at least one entity of the at least one second entity to the defined task service and performance of the defined task service.

17. The computing device of claim 16, wherein, to select the one or more data values, the at least one processing device is further configured to:
select at least one data value from at least one of the contribution data or the second distilled data of the at least one entity of the at least one second entity based on the similarity and the at least one correlation.

18. A non-transitory computer-readable medium embodying at least one program that, when executed by at least one computing device, directs the at least one computing device to:
obtain distilled data respectively corresponding to a plurality of entities, the distilled data being representative of local data of each of the plurality of entities;
learn a similarity between a first entity of the plurality of entities and at least one second entity of the plurality of entities with respect to a defined task service based on first distilled data of the first entity and second distilled data of each of the at least one second entity, the distilled data comprising the first distilled data and the second distilled data;
select one or more data values from the second distilled data based on the similarity; and
provide the one or more data values to the first entity for implementation of the defined task service based on the one or more data values.

19. The non-transitory computer-readable medium according to claim 18, wherein the distilled data, the first distilled data, and the second distilled data respectively comprise latent representations generated using a variational autoencoder long short-term memory deep generative model, the latent representations being invariant to defined features of each of the distilled data, the first distilled data, and the second distilled data.

20. The non-transitory computer-readable medium according to claim 18, wherein, to learn the similarity, the at least one computing device is further directed to:
perform a cross-correlation similarity operation using a bilinear attention unit to compare the first entity with each of the at least one second entity with respect to the defined task service based on the first distilled data and the second distilled data.
